(19) United States
(12) Patent Application Publication
(10) Pub. No.: US 2002/0087915 A1
(43) Pub. Date: Jul. 4, 2002

(54) Error handler method and system for internet-based applications

(76) Inventors: Jesse Perla, Toronto (CA); Dale Baik, Willowdale (CA); Kartik Shah, Thornhill (CA)

Correspondence Address: FASKEN MARTINEAU DuMOULIN LLP, Toronto Dominion Bank Tower, Ste 4200, P.O. Box 20, Toronto-Dominion Centre, Toronto, ON, M5K 1N6, CA

(21) Appl. No.: 09/837,632

(22) Filed: Apr. 19, 2001

Related U.S. Application Data
(63) Continuation of application No. PCT/CA01/00149, filed on Jan. 31, 2001.
(63) Continuation-in-part of application No. 09/471,135, filed on Dec. 23, 1999.

(30) Foreign Application Priority Data
Jan. 31, 2000 (CA) 2,297,596
Jan. 31, 2000 (CA) 2,297,597
Jan. 31, 2000 (CA) 2,297,711

(51) Int. Cl. H04L 1/22

(52) U.S. Cl. 714/15; 709/203

(57) ABSTRACT

A method for generating error messages in a web based application, said method comprising the steps of searching said application for a predetermined error number; retrieving an error message corresponding to said error number; applying said error message to a style sheet in an error form; and displaying said error form on a requesting device.

The present invention relates generally to a computer-based method and system for handling errors in World Wide Web based applications, and more particularly to a schema for supporting multilingual error handling.

### BACKGROUND OF THE INVENTION

The rapid growth of the Internet and more specifically the World Wide Web (WWW or Web) as a network for the delivery of applications and content, has resulted in software developers quickly beginning to shift their focus towards making the web browser a key tool to access information. The presence of the Web has become international to the point that although North America is the leading market, it is not the only market to target applications and services. Furthermore, there is a movement by international companies towards external hosting of applications that may access the data in a distributed manner across the Internet. External hosting requires remote execution of data. The implementation of Unicode as part of Extensible Markup Language (XML) and Extensible Stylesheet Language (XSL) standard is one of the reasons allowing applications to be made international. Unicode is a standard for interchanging, processing, and displaying a plurality of languages. Therefore, developers are able to internationalize applications with separate stylesheets.

While computer terminals and other devices that are configured to receive HTTP and HTML files may utilize the above methods to access and view the Internet data, other devices may not. Specific display standards for non-PC based browser devices such as PDA's, telephones, cell phones, television set-top boxes and similar devices, as well as the display capabilities for these devices allow only a limited view of HTTP transferred HTML files. In addition, these device display characteristics do not permit a user to take advantage of the hypertext features imbedded in most HTML data files.

Web based applications are generally comprised of a plurality of forms, which are connected to achieve a desired flow. Increased demand for web based applications have strained the previous technology to a point where developers are incapable of rapidly delivering applications that can target the diverse browsers, devices and target languages.

A further problem with current web-based applications arises from inability of these applications to easily handle errors. Typically, mark-up based applications are accessible through web services. As mentioned earlier, an application is an autonomous collection of forms defined by a flow and which may include connectors to databases, sequences, functions, and data. Generation of error is strings is typically performed by generating specific code having complicated chaining logic. UNIX multi-language, for example, error language is one attempt at addressing this problem.

Software developers, rather than support and administration staff, usually design error handling. Also, since developers typically develop in a single language, it is difficult to create error string handling in other languages where the application may be used.

This is fundamentally wrong since it obfuscates the difference between debugging code and user centric error handling. Developers rarely understand this difference and while debugging is useful during development, the turn over is difficult.

With component software, the developer does not really have complete control over all the errors that are being thrown. While it is technically possible to solve a lot of these problems with smart error chaining and string lookup tables, a fundamental rule of quality assurance (QA) dictates that the majority of bugs are caused by error handling.

Accordingly, there is a need for error handling to be formalized, particularly in web-based applications. The existing problems are exacerbated by the confusion between form specific and application wide error messages.

Furthermore there is a need in multilingual applications for error messages to be presented to the user at runtime that are “friendlier” than heretofore.

### SUMMARY OF THE INVENTION

An advantage of the present invention is derived from the observation that data is separated from a stylesheet and from program flow. The separation of the flow and form meta-data allows for a separation of data from stylesheets. Otherwise, the stylesheet must maintain maps of where it receives its data from as well as the relationships to different forms. The invention solves this problem by the creation of a schema, which provides all of the flow and Meta information in an external file.

A feature the invention is that at runtime, when an error occurs in the web application a process retrieves an error text and applies it to a stylesheet in an error form. The processed error form is then displayed to the user on their device. The error text can be retrieved from either the web application or a CEM component error.

A further aspect of the invention provides for the developer to provide alternate localized error text at the application or form level.

### BRIEF DESCRIPTION OF DRAWINGS

Embodiments of the invention will now be described by way of example only, with reference to the accompanying drawings in which:

FIG. 1 is a block diagram depicting a wireless network system;

FIG. 2 is a block diagram depicting the major components in a system according to an embodiment of the present invention;

FIG. 3 is a schematic diagram of the application element structure in a Hosted Markup Language application;

FIG. 4 is a schematic representation of the form element structure in the Hosted Markup Language;

FIG. 5 is a schematic representation showing the structure of the Runtime Markup Language;

FIG. 6 is a block diagram of the high level components for processing of HML to generate RML;

FIG. 7 is a block diagram showing the flow for the execution of components described in FIG. 6;

FIG. 8(a) is a schematic diagram of a Bank account query application;

FIGS. 8(b)-(d) is a schematic representation of an HML file for the Bank account query application;

FIGS. 9(a), (b) and (c) are mark-up language representations of a sample generated RML for the Bank account query application;

FIGS. 10(a) and (b) are mark-up language representations of an XSL style sheet for the Bank account query application; and

FIG. 11 is a mark-up language representation of a WML document returned to a device in the Bank account query application; and

FIG. 12 is an error message screen displayed to a user.

### DETAILED DESCRIPTION OF THE PREFERRED EMBODIMENTS

In the following description, the same reference numerals will be used in the drawings to refer to the same or like parts.

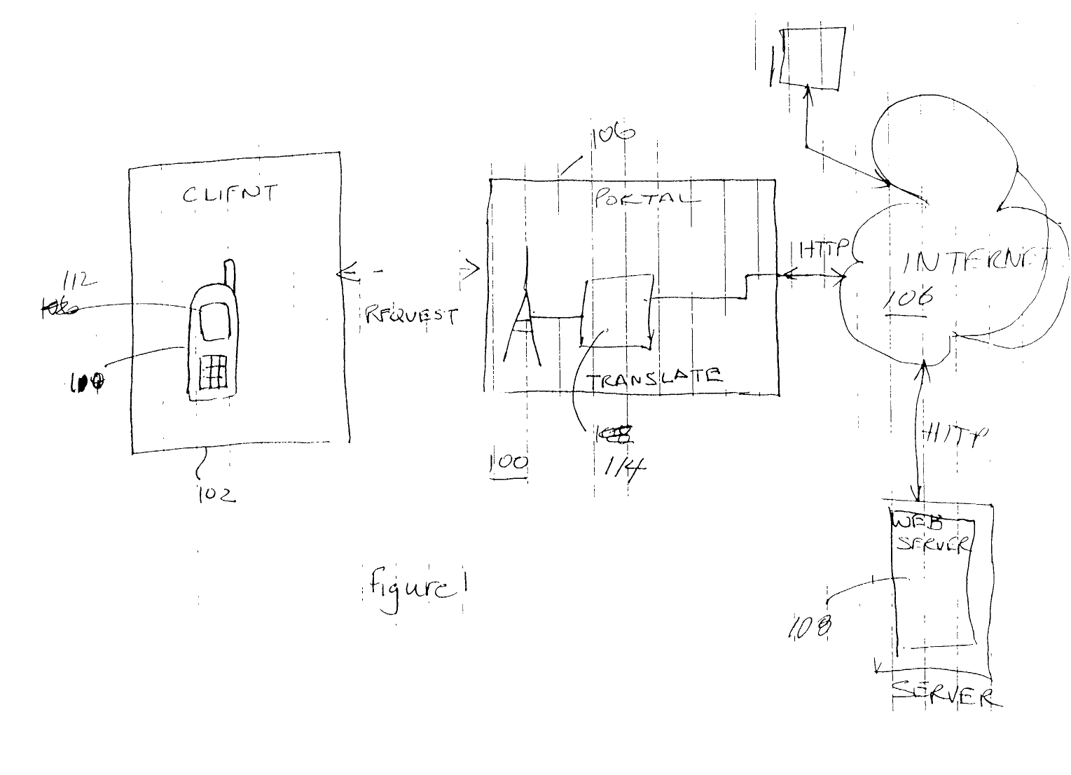

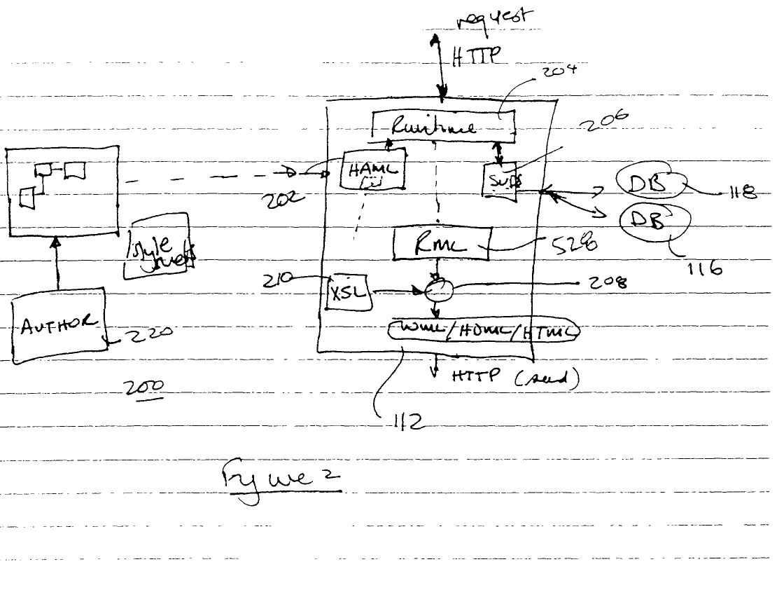

Referring to FIG. 1, a block diagram of a data communication system in which the present invention may be used is shown generally by numeral 100. The present invention is described in the context of the Internet, wherein client devices 102 make requests, through a portal or gateway 104, over the Internet 106 to web servers 108. Web servers 108 are capable of communicating via HTTP, HTTP/S or similar and providing information formatted with HTML codes the client 102 which may be capable of interpreting such codes or may rely on a translation by the portal 106. In this embodiment, HTML is described as one example and the gateway may or may not translate.

In fact, a gateway is not necessary for the majority of connecting devices. In a particular instance, the client 102 may be a cell phone device (or telephone) 110 having a screen display 112. The portal 104 may be a cell phone gateway 114 that routes calls and data transfers from the telephone 110 to a PSTN or other cellular phone networks. The cell phone gateway 114 is also capable of routing data transfers between the telephone 110 and the Internet 106. The communication between the telephone 110 and the cell phone network 114 is typically via the Wireless Application Protocol (WAP). The cell phone gateway 114 typically translates the call to HTTP, which is well known in the art, and communicates with the Internet 106. Furthermore, it is assumed that the telephone 110 and the cell phone gateway 114 implements the appropriate protocols for a web browser or similar that can retrieve data over the Internet and translates the data file for display on the device display 112.

The system 100 also includes at least one host server or web server 108, which is a remote computer system that is accessible over the Internet 106 to the cell phone gateway 114 and the telephone 110. The web server 108 includes data files written in a markup language, which may be specifically formatted for the screen display 112 of the telephone 110. This language could comprise a standard text based language similar to HTML or could include Wireless Markup Language (WML), Handheld Device Markup Language (HDML), another specifically designed markup language, or simply text to send to the phone 110.

The web server 108 may also include an application which is run on the server and is accessible by the telephone 110 specifying a Uniform Resource Locator (URL) or similar of the application. At present, the system 100 operates by the telephone 110 transmitting a request to the cell phone gateway 114. The cell phone gateway 114 translates the request and generates a corresponding HTTP formatted message, which includes the requested URL. In accordance with the URL, the HTTP request message is transmitted to the web server 108 where a data file is located. The data file must be formatted to be compatible to the display capabilities of the telephone 110. The web server calls a process, which invokes an XSL stylesheet interpreter with the appropriate HTML and the stylesheet to create the formatted markup of the appropriate MIME type. In some cases both the XML input and the XSL stylesheet may be provided to the client browser to interpret if the client has an XSL built.

By way of background, Extensible Markup Language, abbreviated XML, describes a class of data objects called dt-xml-doc XML documents and partially describes the behavior of computer programs which process them. XML is an application profile or restricted form of SGML, the Standard Generalized Markup Language. By construction, XML documents are conforming SGML documents. XML documents are made up of storage units called entities, which contain either parsed or unparsed data. Parsed data is made up of characters some of which form character data dt-chardata, and some of which form markup. Markup encodes a description of the document's storage layout and logical structure. XML provides a mechanism to impose constraints on the storage layout and logical structure.

A software module called an XML processor is used to read XML documents and provide access to their content and structure. It is assumed that an XML processor is doing its work on behalf of another module, called the application, which resides on the web server 108.

Each XML document has both a logical and a physical structure. Physically, the document is composed of the units called entities. An entity may refer to other entities to cause their inclusion in the document. A document begins in a “root” or document entity. Logically, the document is composed of declarations, elements, comments, character references, and processing instructions, all of which are indicated in the document by explicit markup. The logical and physical structures must nest properly.

Each XML Document contains one or more elements, the boundaries of which are delimited by start-tags and end-tags. Each element has a type, identified by name, sometimes called its “generic identifier”(GI), and may have a set of attribute specifications. Each attribute specification has a name and a value.

Style Sheets can be associated with an XML document by using a processing instruction whose target is xml-stylesheet. This processing instruction follows the behavior of the HTML 4.0. The xml-stylesheet processing instruction is parsed in the same way as a start-tag, with the exception that entities other than predefined entities must not be referenced.

XSL is a language for expressing stylesheets. A stylesheet contains a set of template rules. A template rule has two parts: a pattern, which is matched against nodes in the source tree and a template, which can be instantiated to form part of the result tree. This allows a stylesheet to be applicable to a wide class of documents that have similar source tree structures.

Each stylesheet describes rules for presenting a class of XML source documents. An XSL stylesheet processor accepts a document or data in XML and an XSL stylesheet and produces the presentation of that XML source content as intended by the stylesheet. There are two sub-processes to this presentation process. First, a result tree is constructed from the XML source tree. Second, the result tree is interpreted to produce a formatted presentation on a display, on paper, in speech or onto other media. The first (sub-)process is called tree transformation and the second (sub-) process is called formatting. The process of formatting is performed by a formatter.

As described above, the prior art technique is tedious and not easily adaptable to different devices and applications and a plurality of user languages. One embodiment of the present invention is thus based on the observation that a solution to the above problem is a separation of data from style sheets, which in turn is separated from program flow. Although it has been recognized that the characteristics of a display needs to be separated from the data, in practice current solutions have failed to understand that the separation of the flow and form metadata is necessary before data can be separated from the style sheets. In other words, at present, style sheets must maintain maps of its data sources and its relationships to different forms. Accordingly, the present invention solves this problem by providing a Hosted Markup Language (HML) for providing flow and metadata information in an external file.

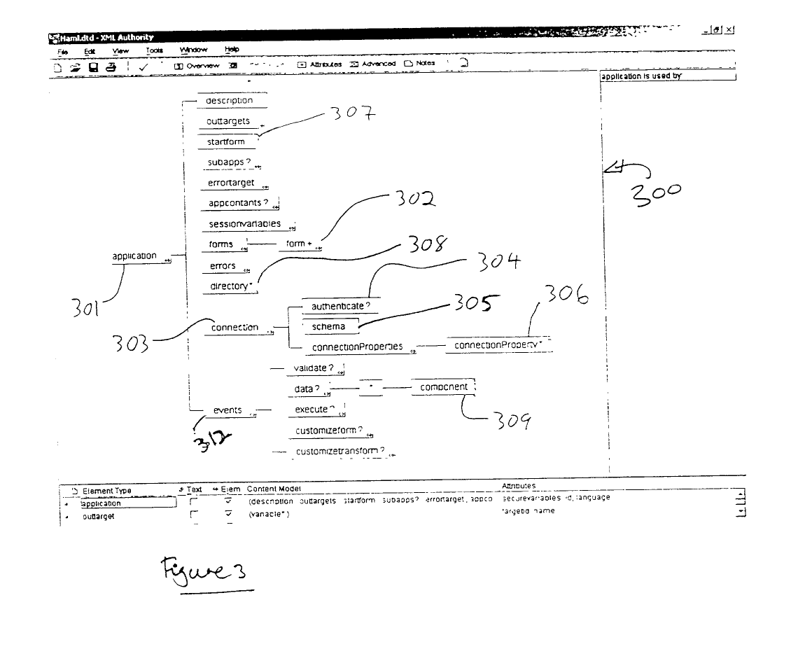

Thus turning to FIG. 2, there is shown at numeral 200, the general components of a system, according to an embodiment of the present invention, for providing a unified data transfer between different devices (clients) and a server over an HTTP based network. The system 200 includes a Hosted Markup Language (HML) file or application 202 written in accordance with the present invention and residing on the web server 108. The system 200 further includes a plurality of style sheets 210 and a run-time program or processor 204 for processing the HML application 202 in response to an HTTP message corresponding to a request received from the client device 102. The HML application 202 includes a plurality of forms and pointers to external data sources. The run-time 204 includes a data server 206 for retrieving data from one or more databases 216, 218 in accordance with the instructions in the HML. The run-time 204 creates a Runtime Markup Language (RML) file 528, which is combined with at least one of the plurality of XSL style sheets 210 by an XSL processor 208.

A further embodiment of the system 200 includes a visual authoring tool 220 for providing a development framework for visually connecting forms defining a look, feel and flow of an application and for generating from the visual layout the HML application 202.

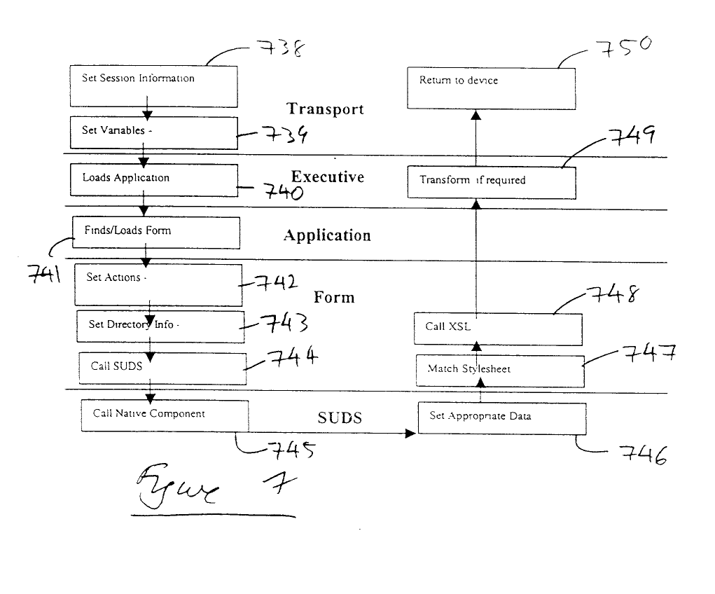

In general, the run-time 204 is called by a client device 102 in a manner as described with reference to FIG. 1, which connects to the server 108 using HTTP. Based on the URL that is requested and the type of device making the request, the run-time 204 determines an appropriate form to use. The run-time calls the data server 206 to obtain data for the URL from the databases 218 and 216. The data server 206 retrieves the appropriate data in XML, and forwards it to the run-time 204. The run-time 204 adds runtime and directory information to the XML data. The data structure that is built or populated by the run-time 204 from HML is termed RML, the structure of which will be described later with reference to FIG. 5.

The run-time 204 calls the XSL processor 208 with the RML and an appropriate style sheet 210 for the form. The XSL processor generates a file that depends on how the XSL stylesheet was written. Specifically, a stylesheet is written for a particular MIME content-type. (It will be described in the description of the RML stylesheet that there is a content-type attribute.) For example if requesting device requires HTML with embedded XSL instructions then the XSL processor will generate HTML. If the requesting device requires a simple test file with embedded XSL instructions then simple text will be generated. Thus if the requesting device has a specific mark-up, the runtime 204 returns the appropriate markup file. However, if the device does not have a specific markup, the run-time transforms the generated HML to an appropriate default markup and sends it back to the device.

The detailed description of the operation and interconnection of the various components will be described in greater detail in the following paragraphs.

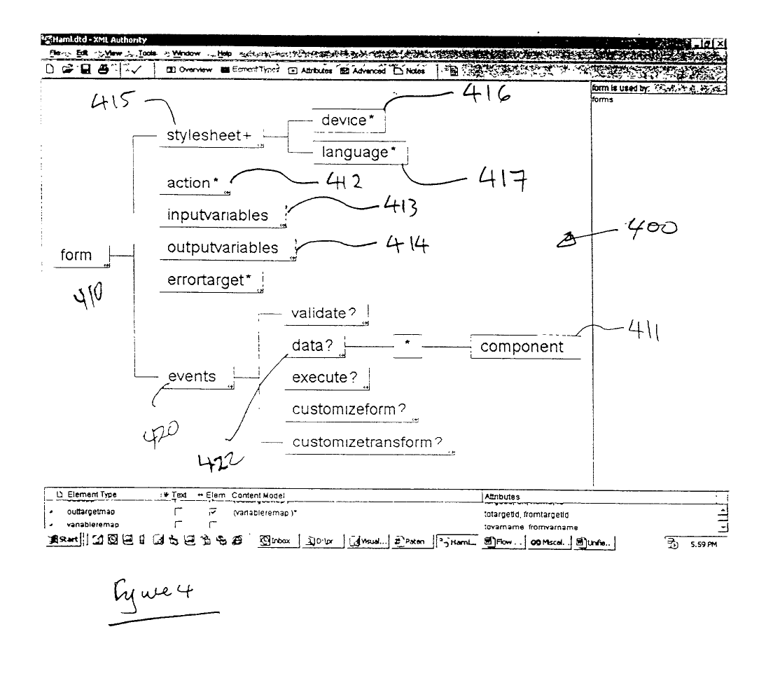

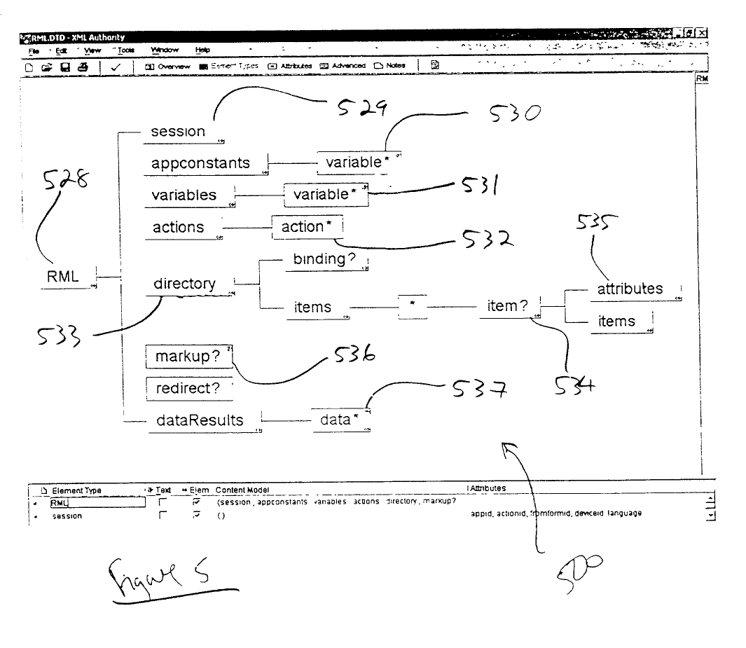

Referring to FIG. 3, there is shown at numeral 300 a defined schema or data structure for the elements contained in an HML application. All of the elements are described as XML-based schemas including attributes and elements. The first element of the HML 300 is an Application Element 301 which is a root element comprising the following:

Key Attributes:

“id” which is a unique identifier for the application;

“language” which describes which variable to extract the user language from.

Children Elements:

startform 307 contains an id attribute, which points to a form's targetid within the application;

forms collection having multiple Form Elements 302;

Multiple Connection elements 303;

A Data element contained within an events element which contains multiple component elements 309;

Multiple Directory elements 308 containing information to connect to directory type data. Contain a name attribute.

Connection Element 303 defines a connection to an outside source of data and comprises the following:

Key Attributes:

“connectionid” which is a unique identifier for the connection;

“type” which determines how to get the data;

“server” which gives the IP address to access the server;

Children Elements:

Authenticate 304

Schema element 305 containing a URL attribute to access the schema information;

Multiple connectionproperty elements 306 providing name/value pairs as inputs to the component defined by the “type” attribute.

Component Element 311 defines an external set of data. Since this element is underneath the application it will be passed to all forms. The Component Element 311 comprises the following:

Key Attributes:

“connectionid” points to a connection element 303;

Authenticate Element 304 defines how to authenticate against an external data source and comprises the following:

Key Attributes:

“user” provides the username for authentication;

“password” provides the external password;

The text of the Authenticate Element 304 can contact CData or any other information that is used by the data server 206 for authentication. Examples of such information include certificates and the like.

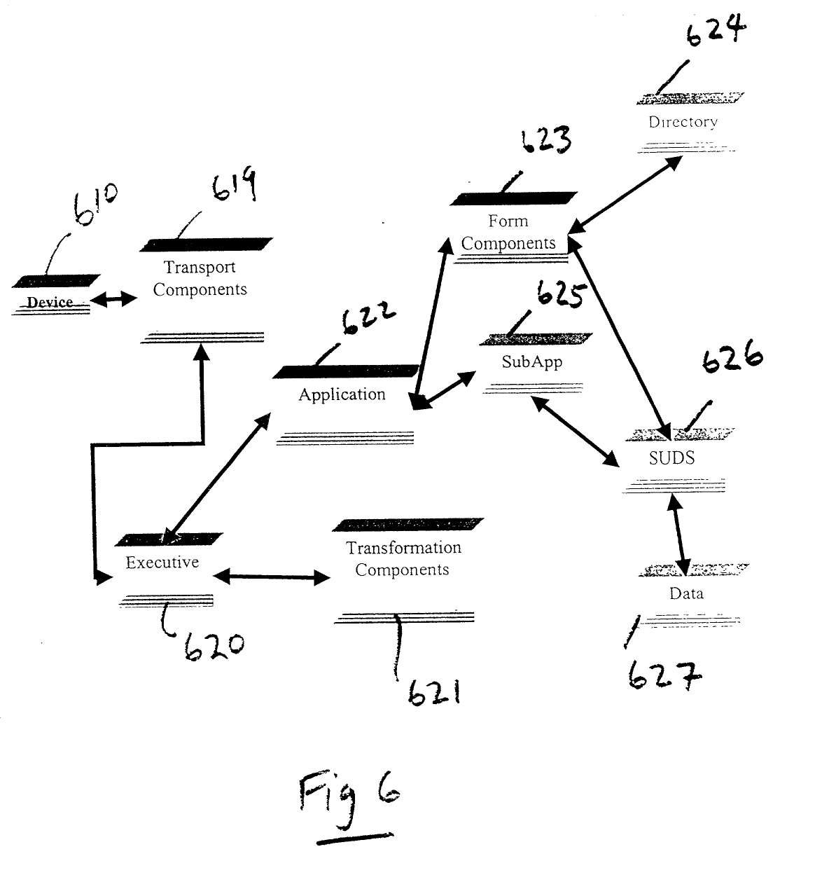

Form Element 302 is shown in detail in FIG. 4 and represented generally by numeral 400. The Form Element 302 defines a form and is contained under the forms collection of the application. The Form Element 302 comprises:

Key Attributes:

“targetid” which is a unique identifier for the form

“language” which describes which variable to extract the user language from.

Children Elements:

Multiple Stylesheet 415 elements

Multiple action 412, input variables 413, and output variables 414 which define the flow and application reuse.

A Data element 422 contained within an events element 420 which contains multiple Component elements 411;

Stylesheet Element 415 defines a potentially matched stylesheet for a form and comprises the following:

Key Attributes:

“URL” defines an external link to the actual XSL file 210 or instead of having an external XSL file 210, the text of the stylesheet element can contain an embedded CData containing the stylesheet contents;

“contenttype” determines the MIME type of the generated XSL stylesheet file. Examples include “text/xml”, “text/plain”, and “text/html” and the like.

Children Elements:

Multiple Device elements 416. The device only has a single attribute “name”;

Multiple Language elements 417. The language element only has a single attribute “language”;

Component Element 411 defines an external set of data. Since this is underneath the form 302 it will only be passed into stylesheets on this form. Otherwise it is identical to the application level Component Element 309 and has the following elements:

Key Attributes:

“connectionid” points to a connection element 303

As described earlier the run-time processor processes the HML and creates and populates a resulting RML data structure. Referring to FIG. 5, the data structure or schema of the RML according to an embodiment of the invention is shown generally at numeral 500. The RML schema is comprised of a plurality of attributes and elements. The first, or root element in the RML element 528. The root element comprises the following:

Children Elements:

Session element 529, Appconstants 530, and Actions 532 defining flow;

Multiple variable elements 531 underneath the variables collection, having a name attribute and the text of which contains the value.

Multiple directory element 533 containing data from directory connections 308

Multiple data elements 537 containing data from data connections 303.

Session Element 529 contains information from the user request and comprises:

Key Attributes:

“appid” points to the id attribute of the Application element 307;

“fromformid” points to the targetid attribute of a form element 302;

“actionid” is the name of the action 412 defined on the form 402 and is used for flow; and

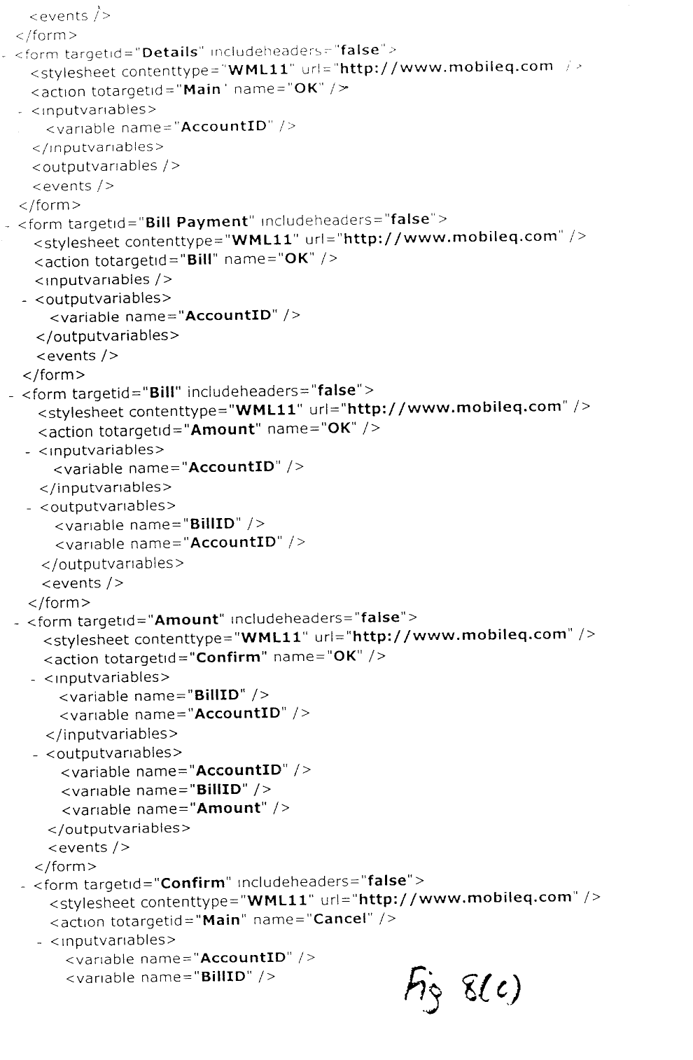

“deviceid” stores the name of the device 102 and links to a value in a device lookup table 553 described later with reference to FIG. 7;

Directory Element 533 is a container for the data from a directory connection. Primary difference between this and the Data element 537 is that the directory connections have a consistent hierarchical schema. The Directory Element comprises:

Key Attributes:

“name” uniquely identifies the directory input. It will be the name attribute from one of the Directory elements in the application 308.

Children Elements:

Contains multiple Item elements 534, which in turn can have its own item elements and attribute elements 535. This defines an arbitrarily deep hierarchy of directory/profiling type data.

The Data Element 533 is a container for the data from a data connection. The Data Element provides a way to store arbitrary XML document fragments within the RML and comprises:

Key Attributes:

“name” uniquely identifies the data. It will be the component id from one of the application 309 or form components 411.

Children elements:

It can contain any hierarchy and elements that are consistent with the defined schema 305 for its components, connections, schema.

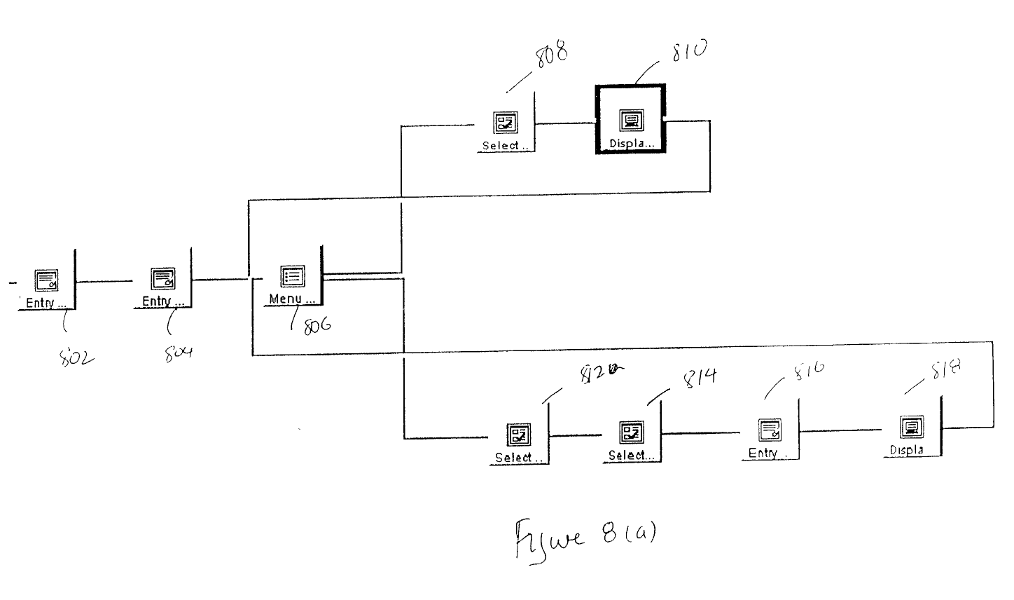

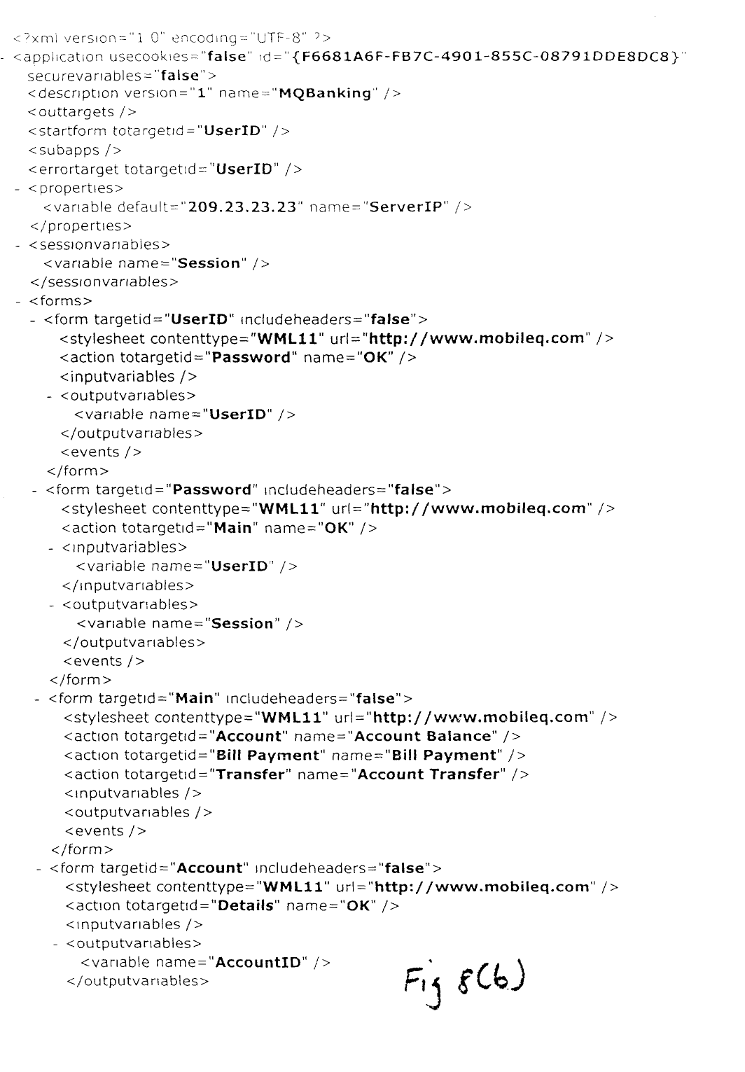

Referring to FIG. 6 there is shown generally at numeral 600, a schematic diagram of the subcomponents of the runtime processor 204. The runtime processor 204 includes transport components 619, an executive 620, transformation components 621, and form components 623. The operation of the runtime processor 204 for generating the RML is now described with reference to FIG. 7. In the following description the term “set” refers to the process of setting or populating pieces of the RML document. The process is described by a sequence of steps 738 to 748. Step 738 is the entry into the process.

At step 738, the transport component 619 receives a call from the requesting device generated through a URL. The transport component 619 processes the incoming HTTP request and extracts, amongst others, the following values, which are used to populate appropriate sections of the RML structure 500. The following values are extracted. The value of the “_SQAPPID” variable in query string/post/cookie is placed into the session element 529 “appid” attribute. The value of the “_SQFORMID” variable in query string/post/cookie is placed into the session element 29 “fromformid” attribute. The value of the “_ACTIONID” variable in query string/post/cookie is placed into the session element 29 “actionid” attribute. The “_SQFORMID” variables on the query string are extracted as values and placed into the session element 29 “fromformid”.

The transport component 619 is also responsible for extracting and determining the “device” attribute within the session element 529. The query string may provide the device attribute directly as a variable called “device” which is directly placed into the “device” attribute of the session element 529 of the RML structure. If the device variable is not set, then a look-up table may be used to determine this value by using the “HTTP_User_Agent” header. A sample look-up table for determining the device variable is shown below in Table I:

TABLE I

| UserAgent | UASubstring | Device | ContentType |
|---|---|---|---|
| UP.Browser/3.1-UPG1 | UP.Browser | UPBrowser | text/hdml |
| UP.Link/3.2 | | | |
| Mozilla/4.0 (compatible; | Mozilla | HTMLDefault | text/html |
| MSIE 5.01; Windows NT | | | |
| 5.0) | | | |

While the UserAgent information is provided in every HTTP request, there is no consistency in the format of the strings between various browsers. Since the system needs to determine the type of the connecting device, a method is necessary to map the value in the string to a name for a device.

The lookup Table I can be stored directly in the HML file, in a database, or in a registry depending on the platform for implementation. The key is that it is easily editable and flexible. The first column in the table is not stored in the actual table but represents real examples of connecting user agent strings for the UP Emulator's HDML browser and Microsoft's Internet Explorer™ HTML browser respectively. The user agent string is matched to rows in the lookup table by performing a UAsubstring search of column two within the incoming HTTP_USER_AGENT header. When a match is found, the corresponding matched device name from column three is placed into the “device” attribute of the session element 529. If no match is found then a default text “HTMLDefault” is placed into the “device” attribute of the session element 529.

At Step 739, which is similar to Step 738, the transport component 619 extracts variables from the HTTP headers and the query string/post/cookies. However, instead of filling in the Session element 529 it fills in the Variable elements underneath the variables element 531 including variables on the query string, post, or in cookies. For example, “http://myserver/transport.asp?var1=a&var2=b” would place two new input variables 31 with name attributes of “var1” and “var2” and values of “a” and “b”. Furthermore, all Custom HTTP Headers are filled in. An example of a custom header from a UP.Link gateway from Phone.com is: “HTTP_X_UP_SUBNO” and the value might be: “919799575-146551_up.mytelco.ca”. This would add an input variable 31 with a name attribute of “HTTP_X_UP_SUBNO” and a value of “919799575-146551 _up.mytelco.ca”.

While the above-described implementation of the transport component 619 relies on data accessible from an HTTP source, it is not limited to HTTP. As long as name/value pairs can be extracted from the incoming protocol the transport can fill in the appropriate RML elements. Similar variations include a transport 619 designed to accept Simple Message Transport Protocol (SMTP) or Wireless Application Protocol (WAP) requests.

In Step 740 the executive 620 is called by the transport 619. The executive 620 uses the “appid” attribute of the Session element 529 to create an application component 622, shown in FIG. 6, based on a match with the “id” attribute of the Application element 301.

In Step 741 the application 622 uses the “fromformid” and the “actionid” of the Session element 529 to find the appropriate form object to create. It does this by looking up the form 302 within its application 301 and matching the “targetid” of the form 302 to the “fromformid”. The application 622 then looks at the action elements 412 within the particular form 410 to find the action whose “actionid” matches the “actionid” of the Session 529. From this action it can find the “targetid” of the form element 302 within the application 301. It uses this form identifier to create the appropriate form component 623, shown in FIG. 6.

In Step 742 the form component 623 traverses the sub-elements of the Form 410 to set to Action element 532 of the RML structure 500.

In Step 743 the form component 623 uses the directory connection 308 information for the application 301 to call an appropriate directory component 624, shown in FIG. 6, and populate the directory RML contained in 533. The details of executing the directory components are described in a separate patent application.

In Step 744 the form 623 creates SOAP based data server components 626 with information to create components to generate arbitrary XML data. The data server components 626 are called for each component in the application level component 309 and the form level components 11. The run-time (??) passes “connectionid” attribute for the data server component 626.

In Step 745 the data server component 626 uses the “connectionid” attribute received to create and execute the appropriate components. The “type” attribute of the connection 303 is the name of the class, which is the handler for this particular type of connection. Examples of classes include “MQProvider.COM”, “MQProvider.Java”, “MQProvider.URL”, and “MQProvider.ODBC”. The data server component 626 creates this class and passes in the complete RML tree 528, the authentication information 304, and all of the connection properties 306. The implementation of the created component uses all of these values to get data from the source defined by its components.

The implementation of these components from data server components 626 is intended to be as general as possible. The only assumption to the functionality of this plug-in (SOAP) is that it takes values as defined in Step 745 and returns back XML data that can be validated by the schema 305 for the connection. The connectionproperty elements 306 are used internally to the component to define where and how the execution occurs. Some implementations include the following examples.

The “MQProvider.COM” requires a connection property 306 called “progid”. It uses the Microsoft COM library to create the object defined in “progid”. It then calls a defined interface on the component and passes in the RML root 528 as an input. It directly takes the output of the component as XML to pass to the next step.

The “MQProvider.URL” implementation might require a connection property 306 called “path”. It uses the “server” attribute of the connection 303 and this path to construct a complete URL. An example is: “http://myserver/mypage.xml”. It then uses Internet functions to access this page over the web. An assumption is that the page returns data in XML, which it directly passes to the next step.

In Step 746 for each of the component “connectionid” attributes, the data server 626 creates a data element 537 in the RML 500 and sets the “name” attribute equal to the “connectionid” attribute. The data server 626 then puts the XML data created in Step 745 as sub-elements underneath this data node.

In Step 747 the Form components 623 use the value in the “language” attribute of the application 301 to find the name of the variable wherein the user's preferred language is stored. A lookup in the variables 531 is performed and the value is placed into the “language” attribute of the session element 529. The rest of step 747 attempts to match the appropriate stylesheet within the form based on the “device” 416 and “language” attributes 417 of the Session element 529. The matching process begins by enumerating the stylesheet elements 415 for the form 410. An exact match of the “language” and “device” attributes in the session 529 to the “name” attributes of the language and device elements 416 and 417 within each stylesheet 415 is sought. If no match is found then the language is set to “default” and attempts the same matching. If still no match is found then the device is changed to “HTMLDefault” and attempts the same matching. This essentially guarantees a match.

In Step 748 the Form component 623 takes the stylesheet element 415 returned from the previous step and uses the URL attribute or the text within the element to get an actual XSL file. It then calls the XSL interpreter 208 with this file and the complete RML 528 as the input. The specific XSL interpreter does not need to be defined since all available interpreters generate some sort of file which represents the file to be sent back to the user.

In Step 749 the Executive 620 decides if a transformation component 621 is required. It does this by looking at the “contenttype” (column four of table I) of the appropriate “device” (column three of Table I) and comparing it to the “contenttype” of the stylesheet 415. If the values are the same then no transformation is required. If they are different then it uses an internal table to determine which transformation component 621 to call. After calling the transformation the resulting form will definitely have the contenttype (column four of Table I) expected by the device (column one of Table I).

In Step 750 the Transport component 619 returns the generated form to the device 102 while setting the “contenttype” of the returned file to be consistent with device column of Table I.

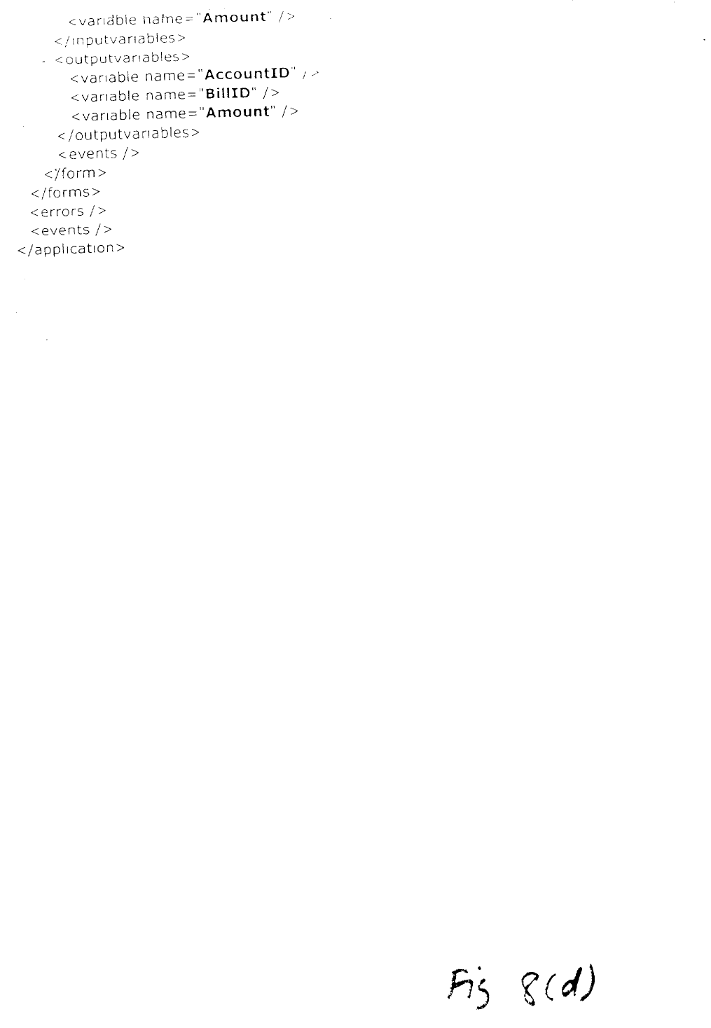

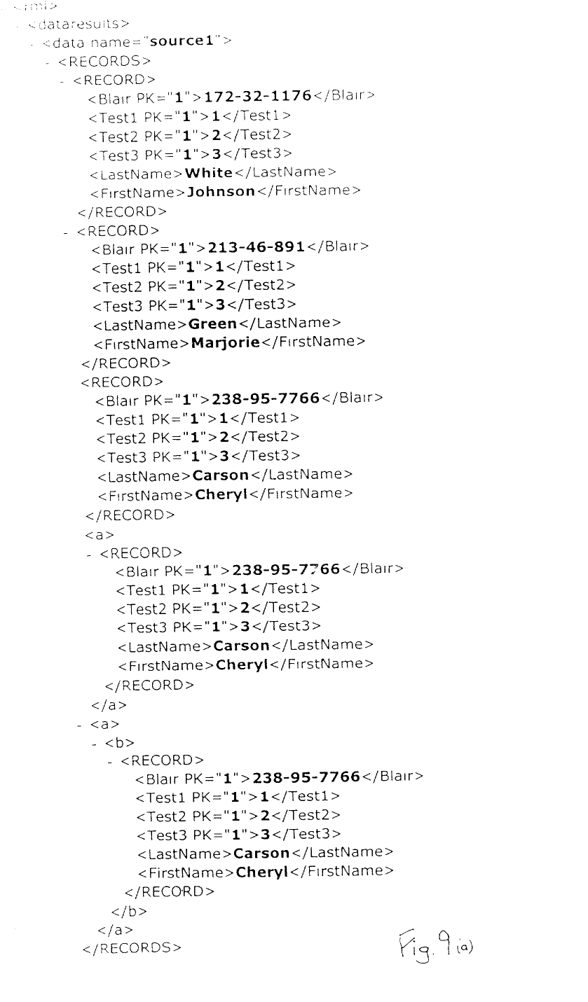

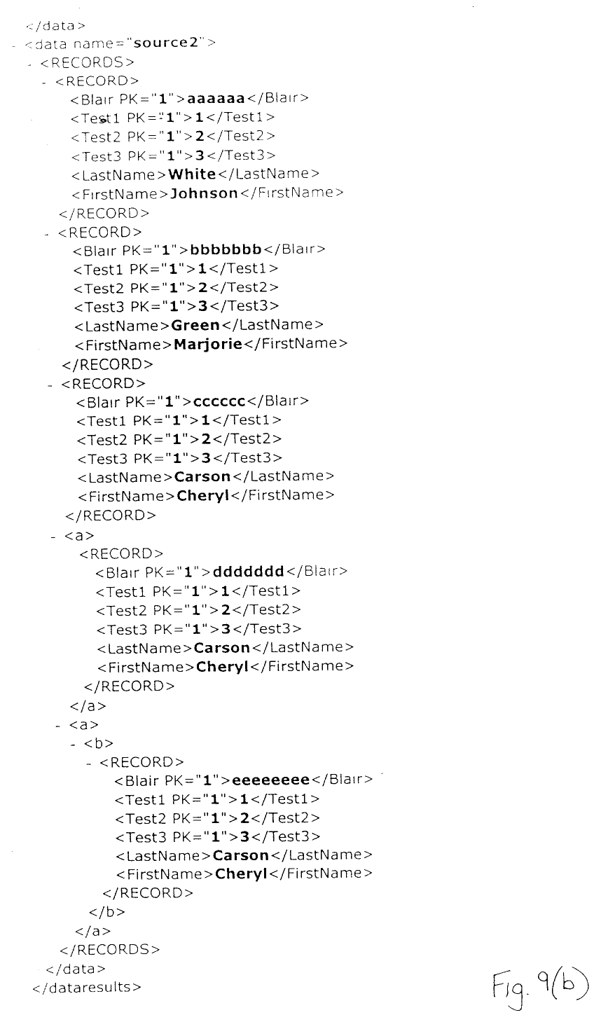

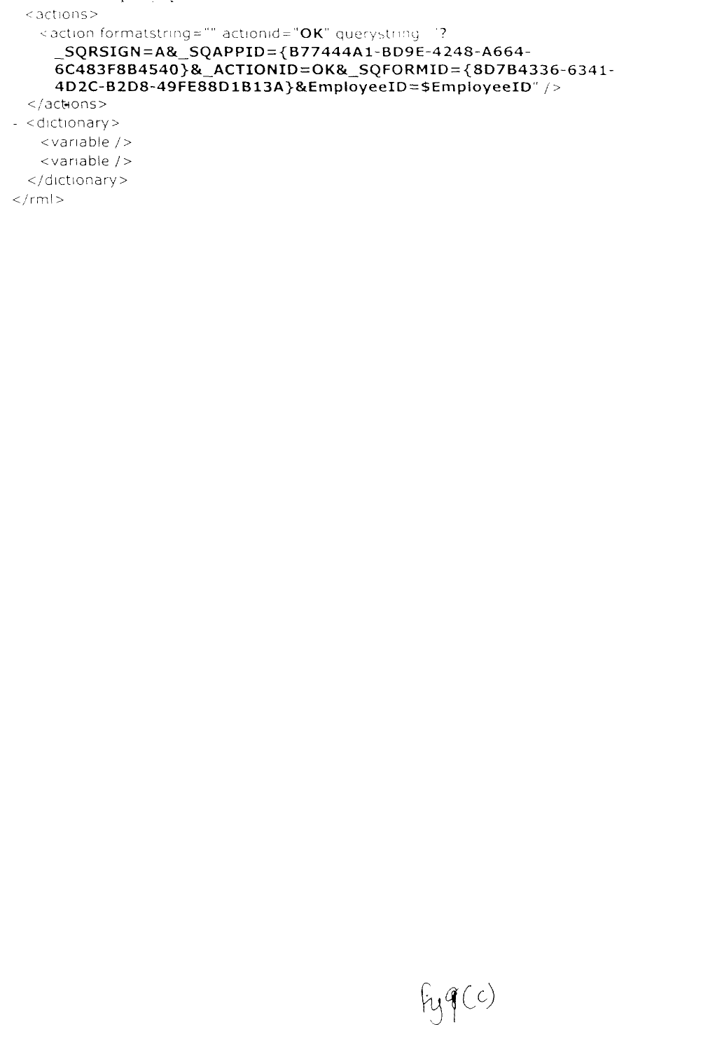

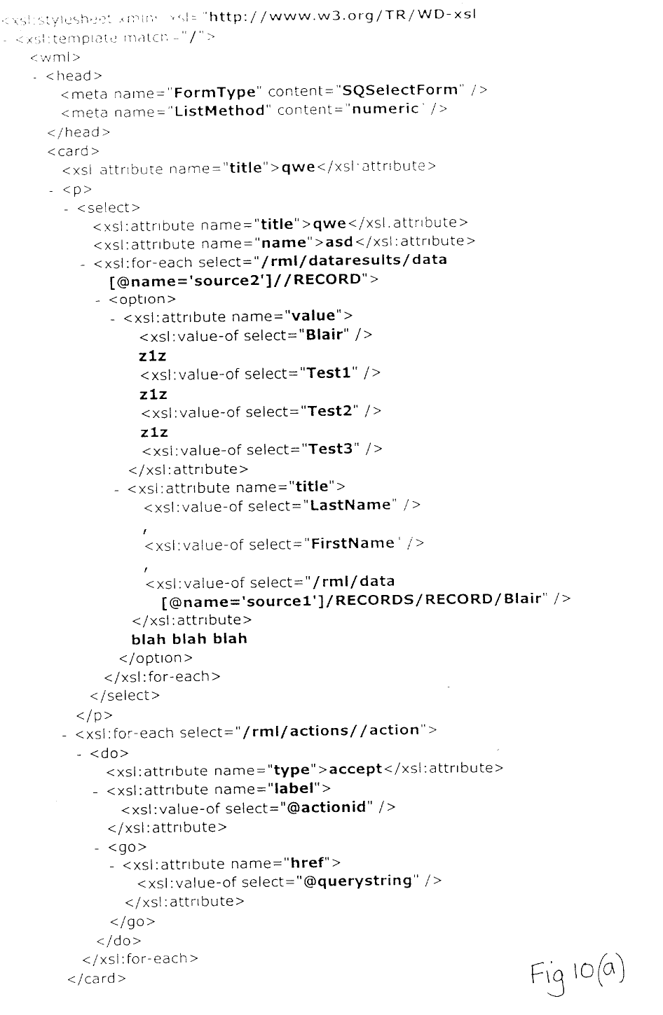

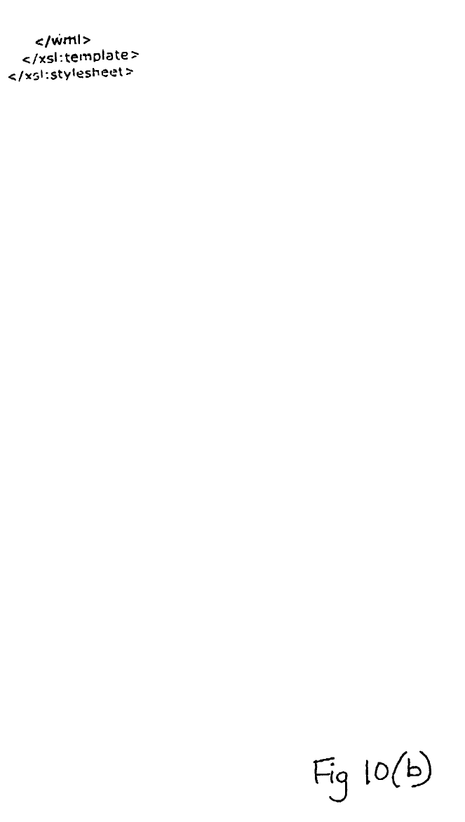

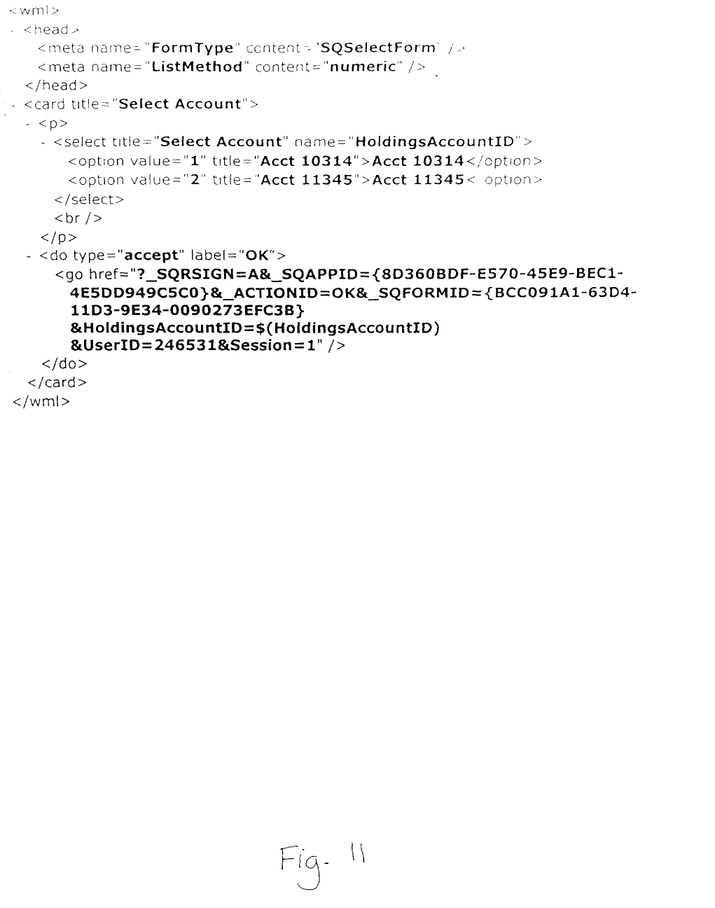

Referring now to FIGS. 8, 9, 10 and 11, there is shown an application of the present invention to an English language WML enabled phone accessing a bank account query application. The application, which is specified in the HML code shown schematically in FIGS. 8(a), is comprised of a sequence of forms 802 to 818. The generated HML is shown in FIG. 8(b)-(d).

Although the above is described with respect to client-server, where the client is a mobile device, the invention is equally applicable to a situation where a client does not have a browser such as in a business to business scenario. Such an example is executing an order from a supplier (server) to a customer (client). Both parties may be server computers wherein a first server (client) requests information from a second server (server). The second server retrieves and formats the information for direct storage in the first server's database. The invention is also applicable to situations where the forms are not displayable. In a further embodiment the invention may be used in an Intranet. These and other embodiments will be apparent to a person skilled in the art.

Furthermore although aspects of the invention have been described with reference to a specific schema, other schemas may also be used with the provision of an appropriate schema processor.

In accordance with another aspect of the invention a mechanism for handling errors in web-based applications is described below.

Given the above schema, it may be seen that multilingual error handling is easily accomplished. This process maybe simply described as follows, as is well known, error numbers are thrown by components in an application. The process in this case may be to simply check the error number to see if it exists at the form level and if not then check for the error number at the application level. Once a match is found at the form level or application level, the processor can access a preset XML schema which defines the error number, error message and language of the requesting device. Furthermore, since the characteristics of the requesting devices known, the system merely merges the error message data with the appropriate style sheet as described above and serves it back to the device for display.

Accordingly, different style sheets could be set up for different devices such as bolding or additional text. Furthermore, the above described error handling provides decoupling from the component development process and decoupling of the error string description from the user description. It also describes a mechanism to dynamically insert variables into the error string independent of the connecting device. Also, inheritance of errors for forms and applications is easily achieved.

The following is an RML of an error form. Note that the variable section contains error variables, specifically the error message.

-<state>

<session appid=“{1E6A1EEB-3C1D-4123-B394-F84B2049A7B1}”
appid_qs=“%7B1E6A1EEB-3C1D-4123-B394-F84B2049A7B1%7D”apptitle=“”
sessionid=“{4F8E1DDB-2B3B-4A25-AF03-13C0B5995699}”
sessionid_qs=“%7B4F8E1DDB-2B3B-4A25-AF03-13C0B5995699%7D”linkid=“_HOME”
fromformid=“”fromformid_qs=“”currentformid=“Display1”currentformid_qs=“Display1”
deviceid=“Generic_HTML32”language=“en”context=“”server=“blair2”
requesttime=“09/08/2000 6:40:10 PM”/>
<constants/>

-<variables list=“_ErrNumber=-2147221504”>

-<variable name=“_ErrFormName”type=“in”>

<value>Error</value>
<encodedvalue>Error</encodedvalue>

</variable>
-<variable name=“_ErrLinkName”type=“in”>

<value>OK</value>
<encodedvalue>OK</encodedvalue>

</variable>
-<variable name=“_ErrMsg”type=“in”>

<value>A very bad error happened</value>
<encodedvalue>A very bad error happened</encodedvalue>
</variable>

-<variable name=“_ErrNumber”type=“in”>

<value>-2147221504</value>
<encodedvalue>-2147221504</encodedvalue>

</variable>
-<variable name=“_ErrNumber”type=“out”>

<value>-2147221504</value>
<encodedvalue>-2147221504</encodedvalue>

</variable>
-<variable name=“_ErrSeverity”type=“in”>

<value>5</value>
<encodedvalue>5</encodedvalue>
</variable>
</variables>

-<links baseurl=“http://blair2/MD/Default.asp”>

<link fromtargetid=“Display1”linkid=“OK”linkname=“OK”
querystring=“http://blair2/MD/Default.asp?_LINKID=OK&_ErrNumber=-
2147221504&_SQAPPID={1E6A1EEB-3C1D-4123-B394-
F84B2049A7B1}&_SQFORMID=Display1&_SQSESSIONID={4F8E1DDB-2B3B-4A25-AF03-
13C0B5995699}“shortquerystring=”http://blair2/MD/Default.asp?_LINKID=OK&_ErrNumber=-
2147221504”/>
</links>

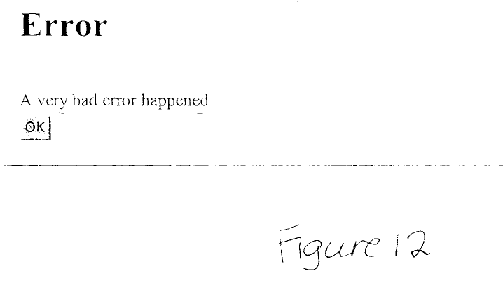

```
  <redirect linkid=“”/>
  <dataresults/>
  </state>
The following is the template XSL that is used with the RML to generate the markup
shown in figure 12.
-<xsl:stylesheet xmlns:xsl=“http://www.w3.org/TR/WD-xsl”>
-<xsl:template match=“/”>
-<HTML>
-<HEAD>
-<TITLE>
-<xsl:choose>
-<xsl:when test=“/state/variables/variable[@name=‘_ErrFormName’]/value”>
  <xsl:value-of select=“/state/variables/variable[@name=‘_ErrFormName’]/value”/>
  </xsl:when>
  <xsl:otherwise>Error</xsl:otherwise>
  </xsl:choose>
  </TITLE>
  <meta name=“PalmComputingPlatform”content=“true”/>
  </HEAD>
-<BODY>
-<H1>
-<xsl:choose>
-<xsl:when test=“/state/variables/variable[@name=‘_ErrFormName’]/value”>
  <xsl:value-of select=“/state/variables/variable[@name=‘_ErrFormName]/value”/>
  </xsl:when>
  <xsl:otherwise>Error</xsl:otherwise>
  </xsl:choose>
  </H1>
  <HR/>
-<FORM NAME=“SQActions”method=“POST”>
-<xsl:attribute name=“ACTION”>
  <xsl:value-of select=“/state/links/@baseurl”/>
  </xsl:attribute>
-<xsl:apply-templates select=“/state/variables/variable[@name=‘_ErrMsg’]/value/node()”>
-<xsl:template>
-<xsl:copy>
  <xsl:apply-templates select=“@*|*|comment()|pi()|text()”/>
  </xsl:copy>
  </xsl:template>
  </xsl:apply-templates>
  <HR/>
-<SCRIPT LANGUAGE=“javascript”>
  <xsl:comment>function SubmitSQRequest(Action, AppID) {document.SQActions._LINKID.value=
Action; if (AppID !=“”) {document.SQActions._SQAPPID.value = AppID;}
document.SQActions.submit();}//</xsl:comment>
  </SCRIPT>
-<INPUT TYPE=“hidden”NAME=“_SQAPPID”>
-<xsl:attribute name=“VALUE”>
  <xsl:value-of select=“/state/session/@appid”/>
  </xsl:attribute>
  </INPUT>
-<INPUT TYPE=“hidden” NAME=_“SQFORMID”>
-<xsl:attribute name=“VALUE”>
  <xsl:value-of select=“/state/session/@currentformid”/>
  </xsl:attribute>
  </INPUT>
-<INPUT TYPE=“hidden”NAME=“SQSESSIONID”>
-<xsl:attribute name=“VALUE”>
  <xsl:value-of select=“/state/session/@sessionid”/>
  </xsl:attribute>
  </INPUT>
  <INPUT TYPE=“hidden”NAME=“_LINKID”VALUE=“_ERROR”/>
-<xsl:for-each select=“/state/variables/variable[@type=‘out’||@type=‘inout’]”>
-<INPUT TYPE=“hidden”>
-<xsl:attribute name=“NAME”>
  <xsl:value-of select=“./@name”/>
  </xsl:attribute>
-<xsl:attribute name=“VALUE”>
  <xsl:value-of select=“./encodedvalue”/>
  </xsl:attribute>
  </INPUT>
  </xsl:for-each>
-<INPUT TYPE=“button”NAME=“button”LANGUAGE=“javascript”
onclick=“SubmitSQRequest(‘_ERROR’,”)″>
-<xsl:attribute name=“VALUE”>
-<xsl:choose>
-<xsl:when test=“/state/variables/variable[@name=‘_ErrLinkName’]/value”>
  <xsl:value-of select=“/state/variables/variable[@name=‘_ErrLinkName’]/value”/>
  </xsl:when>
  <xsl:otherwise>OK</xsl:otherwise>
  <xsl:choose>
  </xsl:attribute>
  <INPUT>
-<INPUT TYPE=“hidden”NAME=“_MQContext”>
-<xsl:attribute name=“VALUE”>
  <xsl:value-of select=“/state/session/@context”/>
  <xsl:attribute>
  </INPUT>
  </FORM>
  </BODY>
  </HTML>
  </xsl:template>
  </xsl:stylesheet>
```

The following is the error definition format that associates error elements with each error number that is to be handled.

```
-<errors defaulterror=“0”>
-<error number=“0”errortarget=“”skiperror=“0”>
  <description language=“en”formtitle=“Error”linkdisplayname=“OK”>Default Error
String</description>
  </error>
-<error number=“-2147221504”errortarget=“”skiperror=“0”>
  <description language=“en”formtitle=“Error”linkdisplayname=“OK”>A very bad error
happened</description>
  <description language=“fr”formtitle=“Error”linkdisplayname“OK”>Une erreur très mauvaise s\acute{ }est
produite</description>
  </error>
  </errors>
```

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for generating error messages in a web based application, said method comprising the steps of:
(a) searching said application for a predetermined error number;
(b) retrieving an error message corresponding to said error number;
(c) applying said error message to a style sheet in an error form; and
(d) displaying said error form on a requesting device.
